(19) United States
(12) Patent Application Publication
(10) Pub. No.: US 2005/0107028 A1
(43) Pub. Date: May 19, 2005

(54) Integrated communication and geographic positioning system and method of using same

(76) Inventors: John P. Westervelt II, Rural Lake County, FL (US); Mario E. Jakob, Umatilla, FL (US)

Correspondence Address: Rigdon Patents & Engineering, P.C., 213 Paradise Marsh Circle, Brunswick, GA, 31525--211, US

(21) Appl. No.: 10/950,258

(22) Filed: Sep. 24, 2004

Related U.S. Application Data
(63) Continuation of application No. 09/732,077, filed on Dec. 7, 2000, now abandoned.

(51) Int. Cl. H04H 1/00

(52) U.S. Cl. 455/3.01

(57) ABSTRACT

An integrated communication and geographic positioning system and method provide integrated mobile communications with individual employees to automate administrative efforts. The system enables the determination of an individual's geographic position and the monitoring of an individual's activity. According to the present invention, such individual information is automatically formatted and accessible by a system user from any wireless communication array.

### BACKGROUND OF THE INVENTION

1. Field of the Invention

The present invention relates generally to the up-link and down-link of communications between a wireless network and the Internet. More particularly, the present invention relates to a system and associated method of operation for appending location data regarding a mobile unit to a wireless network including an Internet interface and server unit having cross-platform formatting capabilities.

2. Background of the Prior Art

Many businesses today provide employees the option of working outside of the office. Moreover, certain businesses such as construction and contracting companies, require projects be performed off-site; thus, often requiring additional employees to maintain constant supervision to ensure proper accounting of work hours and project execution. For example, the construction business retains employees who are often required to work out of the office at a construction site. As is often the case, a foreman or some supervisory figure is usually required to be present at the site to ensure worker's are in attendance and executing assigned work. Nonetheless, at times, a foreman or supervisory figure is unable to adequately supervise all workers or an employer lacks sufficient funds to maintain a foreman at the construction site.

Currently, systems are available that disclose various aspects of communication and location tracking tools. For example, a system is presently available for determining the location of an operating cellular phone without placing a call to the mobile cellular phone and without the knowledge of the individuals in possession of the mobile phone. A user of the system must place a call to a special number to activate the geographic location function. Given the proper authentication, the user may then request a location update from the system. However, the system suffers from certain deficiencies. For instance, the system does not operate continuously, nor does it provide any useful information other than location.

Another available system provides customized location information obtained from a website based upon input from a mobile communications device. The purpose of the system and its method is to automatically update user request location data in order to retrieve location specific information, such as map directions. A feature of the system determines if a particular communication requires location data, and includes the location determination in the response. The system fails to provide the ability to track user information other than location data.

Also currently available is an apparatus for updating a communications network. The apparatus uses preexisting time-based features within a communication device to control transmission of information between the communications device and the communication network. The apparatus appears to synchronize information maintained in a multitude of locations by time and/or geographic location triggers. Such apparatus, however, is unable to support streamlining collected data generated from a multitude of locations to automatically generate specific information.

The foregoing available systems and apparatus are unable to fully integrate a means for identifying location of a mobile unit, for gathering and relaying information to at least one mobile unit, and for streamlining collected data to generate various information portfolios. As such, there is a need for a system to automatically monitor an individual's location and activities, to gather and account monitored data while also having the ability to relay information between the individual and system user.

### SUMMARY OF THE INVENTION

The present invention enables a system and method to overcome the limitations identified above as well as limitations in other prior systems. An object of the invention is to enable a user to advantageously track and direct individual activity at multiple locations through a server unit. A related object of the invention is to enable an improved method for enhancing labor resource allocation for multiple, simultaneous projects.

Another object of the invention is to provide an improved apparatus for monitoring and presenting individual activity.

Another object of the invention is to provide for an improved apparatus for generating useful information based on monitored data. A related object of the invention is to enable an improved apparatus that utilizes monitored information and streamlines data for management and financial purposes. A further related object of the invention is to enable, an improved apparatus that provides streamlined data to various interested system users.

Another object of the invention is to enable ease of access by system users.

Another object of the invention is to enable a smaller administration base for 20 'system users by: providing direct input of cross-platform formatted data into all-purpose management/accounting software.

Specific objects include automatic input of project/user information comprising labor hours and tasks performed into a system user terminal.

A further object is to maintain positive accounting of employee time and location throughout a project or workday.

In order to achieve the above objects, an integrated wireless communication and geographic positioning system that communicates with and produces location data from a wireless mobile device is enabled, in accordance with the present invention. The system streamlines information gathered, including geographic position, to be delivered to a user through an Internet interface providing cross-platform formatted data for user administration. Preferably, software for implementing a system to track, account and automatically format data is incorporated into a communication network server.

The system according to the present invention includes a wireless network comprising a geographic position determination unit, a wireless mobile communications unit, and a server unit, as well as a network interface. The geographic position determination unit indicates the location of a mobile unit operating within the wireless network. Such location information is sent via communication through a navigable network interface and server unit to provide a user with streamlined data for administration of project information, labor hours and activity, and the like.

The navigable interface, such as an Internet interface, is coupled to a server unit that distinguishes the various communications by a user of a system enabled by the present invention. A form of communication via a navigable interface by a user of the system is a request for the location of a mobile unit. A server unit, preferably coupled to an Internet interface, enables determination of the communication as a request for mobile unit location and will access the geographic position determination unit for location data. The location data is communicated via Internet interface and formatted by the server unit for download to a predetermined administrative software application.

A method of operation according to the present invention operates consistently with the described structure. In the method, a first step includes receiving communications from the wireless network. Next, the method includes parsing the communications to determine if it includes a request for information on mobile unit location. Then, the method includes identifying the requested mobile unit and producing a locate response which is then used to determine the location information. The location information is then appended to the wireless communication and automatically formatted for system user download.

The geographic location of a mobile unit is determined from geographic information provided to the server unit from such methods as a space based GPS-type satellite platform, a device performing triangulation calculations, a device which performs time-delay distance calculations, or a transceiver from a mobile cell which Is determines the strongest signal from the mobile unit among a plurality of mobile cells. Other suitable means may also be employed.

To monitor individual activity, a geographic position system for location is not required for all embodiments. Consequently, a geographic position system for location is optional. Instead, a system is consistent With the present invention where individual information is appended to a mobile unit through a wireless network and such information is automatically formatted and communicated directly to a server unit. Individual activity data is useful for monitoring individuals in such fields as medicine, sports, detention, or the like. For example, medical insurance companies currently lack an effective means of monitoring medical personnel efficiency. The present invention enables a means for compiling data on medical personnel activity for statistical applications in providing such information as efficiency bases, and the like.

According to the present invention, another feature includes the ability for users to communicate instructions and messages to an individual operating a mobile unit via a computer network wherein an interface coupled to a server unit enables communication. As long as a mobile unit is powered-on, instructions, messages, and location data can be relayed between a system user and the mobile unit via a network coupled to a server consistent with the present invention.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a diagram illustrating an installation of an integrated wireless communication and geographic positioning system according to the present invention;

FIG. 2 is a high-level block diagram illustrating a wireless network for communicating information from a system user to an individual mobile unit in accordance with the present invention;

FIG. 3 is a block diagram illustrating a process for communicating across a wireless network for relaying information from a mobile unit to a system user in accordance with the present invention;

FIG. 4 is a block diagram presentation for a more detailed description of features of a portion of FIG. 3;

FIG. 5 is a high-level block diagram illustrating various categories of application modules included in a server unit designed in accordance with the present invention;

FIG. 6 is a block diagram of the “home” module of FIG. 5 in accordance with the present invention; and

FIG. 7 is a block diagram of the “login services” module of FIG. 5 in accordance with the present invention.

### DETAILED DESCRIPTION OF THE INVENTION

The invention summarized above and defined by the enumerated claims may be better understood- by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

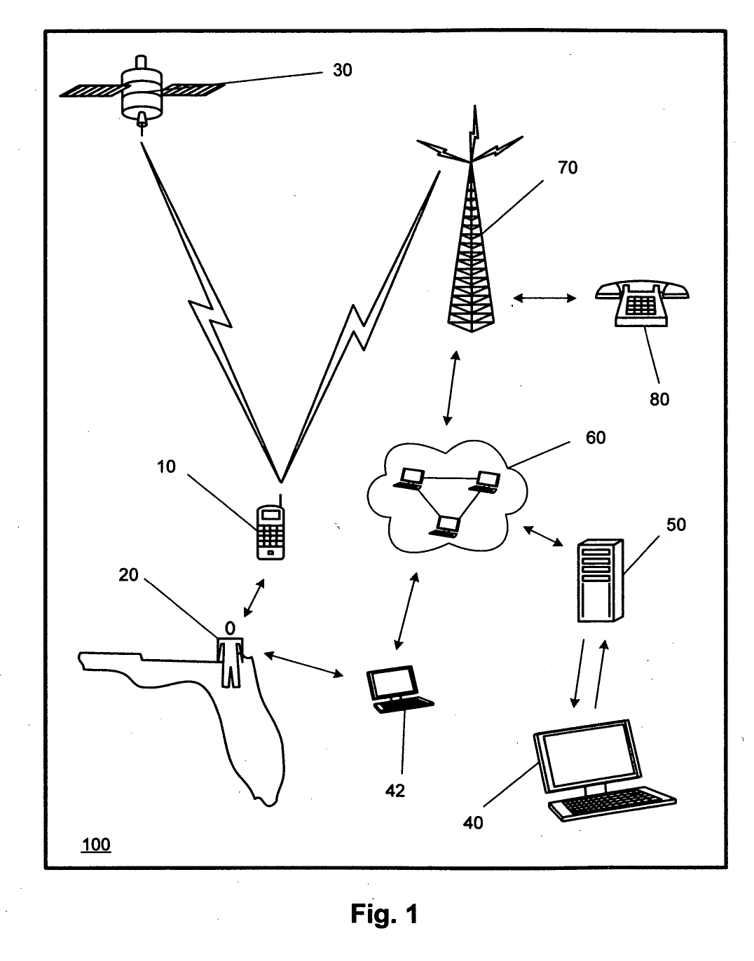

FIG. 1 illustrates a general diagram of a wireless network, system 100 constructed according to the present invention. As shown, the system 100 includes at least one mobile unit 10 to be used by an individual 20, a geographic determination unit 30, a computer terminal 40 for access to system 100 by a system user, a server unit 50 connected to navigable interface 60, and transceiver station 70. According to the present invention, mobile unit 10 enables a means for individual 20 information relay. Mobile unit 10 is a wireless telephone, a computer, or any other device capable of wireless telecommunications.

Geographic position determination unit 30 provides geographic location of mobile unit 10 to a system user. Geographic position determination unit 30 may be a space-based satellite platform, such as a GPS system, or any other satellite system which functions to geographically pinpoint an object on earth using various known methods. Geographic position determination unit 30 may also include a device for performing triangulation calculations, a device which performs distance delay calculations, or a transceiver from a mobile cell, which determines the strongest signal from a mobile unit among a plurality of cells.

To locate mobile unit 10 or provide and receive information from mobile unit 10, a system user may communicate through a computer network wherein computer terminal 40 communicates directly with server unit 50 or communicates with server unit 50 via navigable interface 60. Server unit 50 is coupled to navigable interface 60, preferably an Internet interface. With computer terminal.40 a system user may directly prompt server unit 50 to access location information of mobile unit 10 by providing an authentication code, or other authorization data. Alternatively, such access may be communicated to server unit 50 via navigable interface 60. Utilizing computer terminal 40, a system user may also be requested to provide the telephone number, or other identification, of mobile unit 10 to be located.

Receipt by server unit 50 of an appropriate authorization code and mobile unit 10 identification, such as phone number information, preferably prompts server unit 50 to initiate a program which geographically locate the position of mobile unit 10 and provide geographic position information to a system user at computer terminal 40. Server unit 50 need not initiate any overt communication with mobile unit 10 to determine the geographic position of mobile unit 10. Rather, server unit 50 operates to convert communications as they pass among system user, geographic position determination unit 30, and mobile unit 10, and individual 20 via navigable interface 60. In an embodiment of the present invention, mobile unit 10 must be powered-on for server unit 50 to retrieve geographic positioning information.

Server unit 50 performs a lookup in a database to provide a system user with geographic position information about mobile unit 10. Server unit 50 may deliver this information to a system user at computer terminal 40 by electrical messaging or other similar communication. To facilitate wireless communication between mobile unit 10 and navigable interface 60 is base transceiver station 70. Base transceiver station 70 may be a radio tower, microwave tower, or the like.

Geographic position determination unit 30 is not required for all embodiments because not all system users require individual 20 positions to be monitored. Consequently, geographic position determination unit 30 is optional. Instead, a system, is consistent with the present invention, wherein individual 20 preferably has an option of communicating via mobile unit i0 to a system user's grounded telephone 80 to physically relay information or location data, or by a separate computer terminal 42 through Internet interface 60 to a system user at computer terminal 40.

Server unit 50 may also operate to convert communications between such components as mobile unit 10, geographic position determination unit 30, individual 20,. and a system user. For example, server unit 50 preferably enables a system user to send/receive instructions or messages to individual 20 and enables a system user to view data regarding individual 20 activity, location, or project. Server unit 50 may also operate to format inputted/downloaded data from geographic position determination unit 30 for accounting software in a system user's computer terminal 40 such as PeachTree® and QuickBooks Pro®, to preferably enable a seamless system to reduce administrative efforts. Additionally, server unit 50 provides data storage for information moving through navigable interface 60.

In yet another embodiment, when individual 20 and mobile unit 10 are outside of the wireless network system 100, the present invention preferably enables a means for information storage and automatic update once mobile unit 10 returns within the wireless network system 100. Such means for information storage include physical input of information into mobile unit 10, into computer terminal 42, grounded telephone 80, or the like. Once such information is delivered to server unit 50, such information is automatically updated for delivery to a system user. Delivery of information to server unit 50 may be immediate Cup computer terminal 42 or grounded telephone 80 or it may be delayed and delivered only upon mobile unit reentry into wireless network system 100.

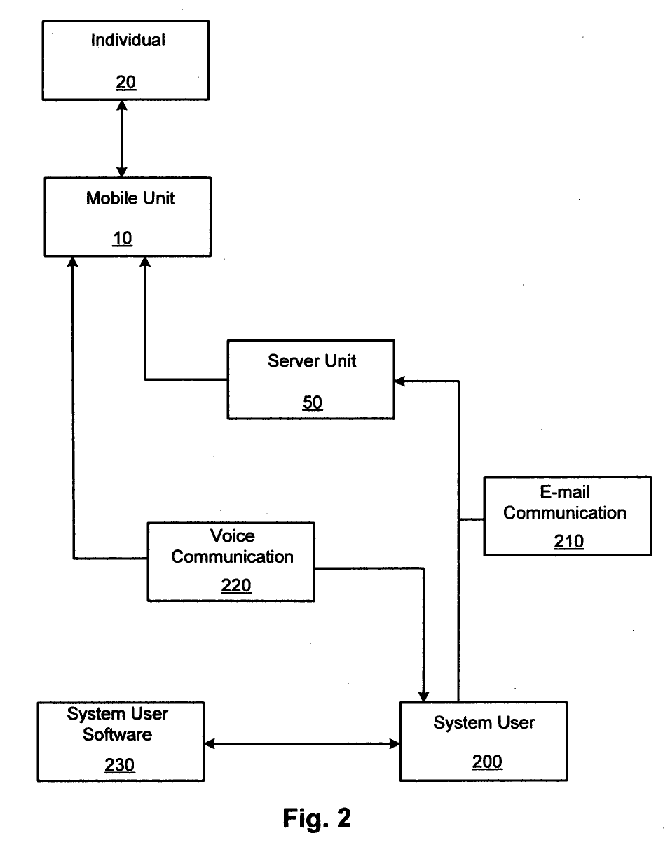

FIG. 2 is a high level illustration of a preferred system for communicating information from mobile unit 10 to a system user in accordance with the present invention. Preferably, system user 200 accesses server unit 50 to send or receive instructions or messages to individual 20 via email communication 210. Individual 20 may receive such instructions or messages or send information to system user 200 through standard email protocol via email communication 210 or via other wireless connection, such as computer logon or voice communication 220. Alternatively, system user 200 may directly access server unit 50 to download geographic position of mobile unit 10.

Once server unit 50 receives information or messages from individual 20 or position data from mobile unit 10, such communications may be downloaded onto system user computer terminal 40 (FIG. 1) and streamlined onto system user software 230, such as QuickBooks®, enabling a seamless system to reduce administrative efforts.

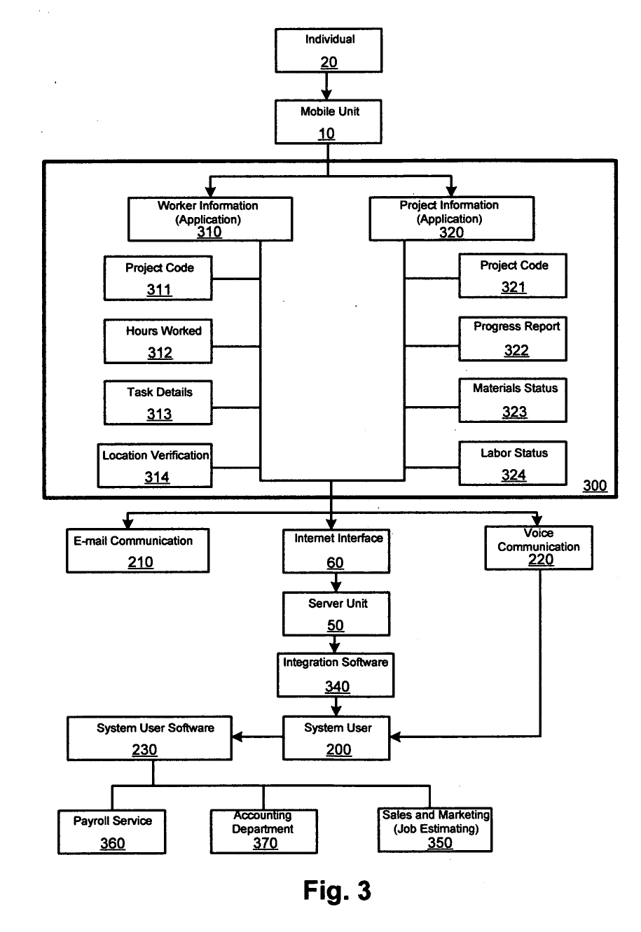

FIG. 3 is a more detailed illustration of a process for communicating across a communication network to relay information from a mobile unit to a system user in accordance with the present invention. Preferably, individual 20 accesses mobile unit 10 to communicate work related information 300 to system user 200. Mobile unit 10 is typically a wireless telephone, a computer, or any device capable of wireless telecommunications.

Individual 20 communicates to system user 200 data 300 comprising detailed worker information 310 and project information 320. Data 300 is preferably used by system user 200 for administrative purposes to monitor individual 20 activity. Worker information 310 may include such details as project code 311, hours worked 312, task details 313, location verification 314, and the like. Project information 320 may include such specifics as project code 321, progress report 322, material's status 323, labor status 324, and the like. Project information 320 is typically based on worker information 310. Data 300 is communicated to system user 200 through various modes of transmission. Such transmission may, include e-mail communication 210 to a server unit 50, direct voice communication 220, or direct communication through Internet interface 60 to server unit 50.

Server unit 50, upon receipt, processes data 300 through integration software 340 to format data 300 to be transmitted to system user 200. Formatted data 300 can be seamlessly applied to system user software 230 wherein data 300 is preferably processed into constructive reports for delivery to various administrative departments such as sales and marketing 350, payroll service 360, and accounting 370. Preferably, sales and marketing 350 utilizes data 300 regarding individual 20 activity for estimating project costs and constraints. Other applications for formatted information include, but are not limited to, wireless electronic time tracking, job and activity cost monitoring, increasing accuracy of cost analysis and industry estimating and employee positioning. In an alternate embodiment such information can be selectively utilized in additional activities such as sports training, and heart monitoring.

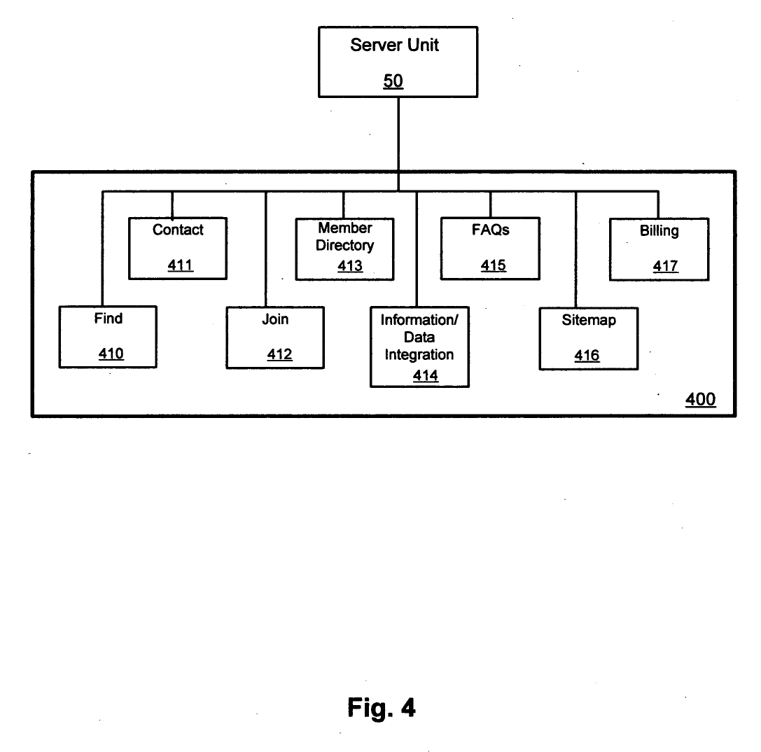

The block diagram in FIG. 4 illustrates global processes of a server unit for access by all communication network system users in an embodiment of the present invention. Global functions 400 of server unit 50 preferably include such functions as: Find 410, Contact 411, Join 412, Member Directory 413, Information/Data Integration 414, “FAQs” (or “Frequently Asked Questions”) 415, Sitemap 416, and Billing 417. Specifically, Find 410 function serves to provide a means for locating information as disseminated by server unit 50. Contact 411 function preferably aids system user 200 in communications with server unit 50 whereas Join 412 function enables new system users ease of access to an embodiment of the present invention. Member directory 413 function preferably comprises a means for storage and access to a database of system user 200 information. Such means for storage and access includes categorizing system user 200 information into a plurality of levels. Server unit 50 also serves to integrate information/data 414 to enable seamless administration by system user 200. Billing 417 provides an accounting and billing function to be applied to system user 200. Activities associated with Billing 417 include tracking system user 200 payments and activity. Finally, the FAQs 415 and Sitemap 416 preferably enable ease of navigation of a website generated by server unit 50 on Internet interface 60.

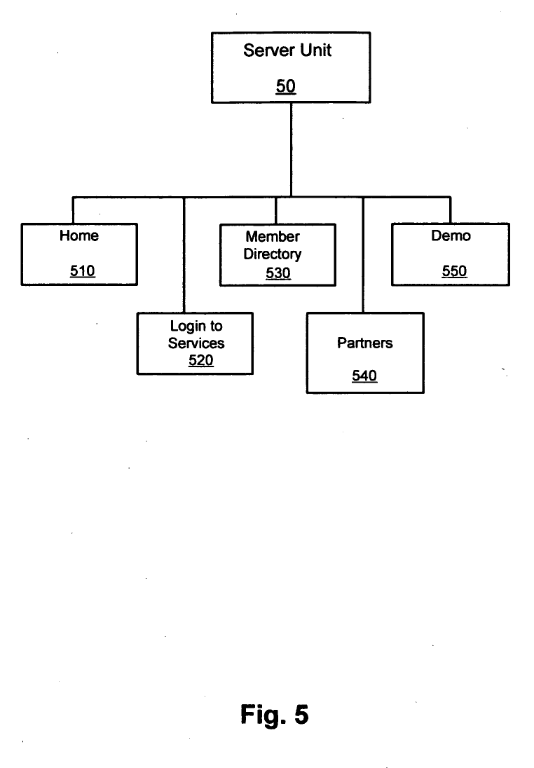

FIG. 5 presents a high level diagram of various categories of application modules included in a server unit designed in accordance with the present invention. Server unit 50 preferably includes such application modules as: home 510, login to services 520, member directory 530, partners 540, and demo 550, to assist system user operation of the present invention. Home 510 application module preferably provides a primary step in accessing information and data from server unit 50. A security guard is enabled by login to services 520 application module. The security guard includes a firewall system or group of systems to enforce an access control policy, encryption software, or the like. Assessment of membership is conducted by member directory 530 application module. A search for partners 540 affiliated with the present invention and demo.550 are two additional application modules enabled by server unit 50.

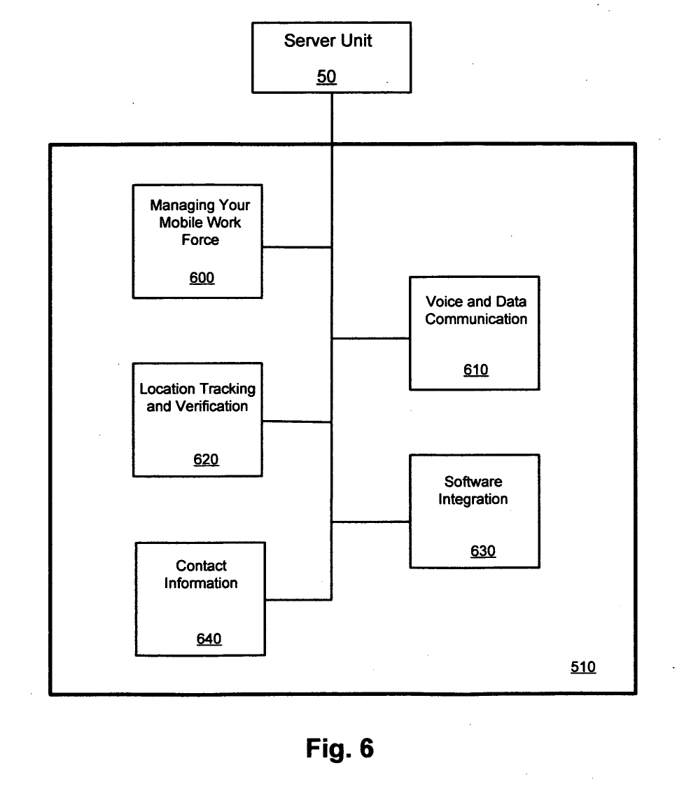

Referring to a specific embodiment as illustrated in FIG. 6 a website browser tool “home” is provided to enable a user to customize and personalize navigation preferences for Internet access. Home 510 application module provides a system user access to such server unit 50 functions as: managing your mobile work force 600, voice and data communication 610, location tracking and verification 620, software integration 630, and contact information 640. The function of managing your mobile work force 600 preferably includes providing general guidelines and preferred practices utilized by others in similar businesses to manage an employee base. Voice and data communication 610 function provides a system user with such features as cellular telephony, wireless web access, formatted data download, email capacity, and the like. The function of location tracking and verification 620 preferably relays to a system user such information as employee time and location profiles, logistics planning, and asset allocation. Software integration 630 preferably comprises data consolidated from server unit 50 and data formatted for direct input to a system user's management software. Additional contact information 640 function preferably provides a system user with information and a means for communicating directly with server unit 50.

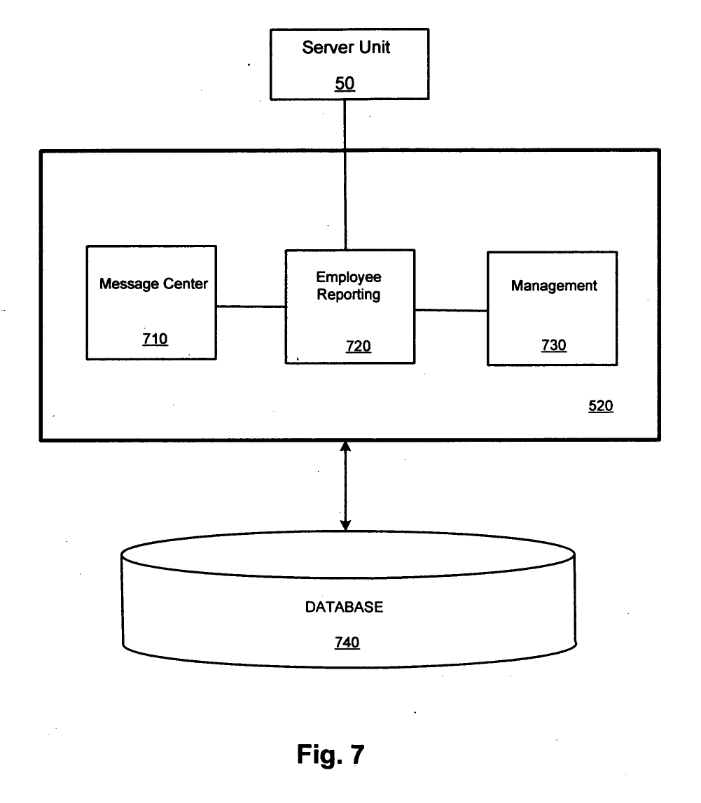

FIG. 7 illustrates preferable features of the “login services” module of FIG. 5 in accordance with the present invention. The login services 520 application module preferably provides a system user with such services as: a message center 710, employee reporting 720, and -management 730. In an embodiment of the, present invention, message center 710 comprises a bulletin board and a messaging mailbox. A bulletin board preferably enables a system user to post, read, and search notices. Alternatively, a system user communicates via a messaging mailbox by, sending, reading, and downloading messages.

Employee reporting 720 feature enables an individual (employee of a system user) to key in field data as well as information regarding a project, such as a job log. A system user can relay individual information and data with management 730 feature. The management 730 feature enables a system user to access such information as employee account management, field activity, downloaded data, or the like.

Wireless communication, geographic positioning information, and project tracking as enabled by login services 520 application module directly communicate with database 740. Database 740 transmits and receives such communications and information transmitted from message center 710, employee reporting 720, and management 730.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description.

1. A system for monitoring the activity of at least one individual by a user comprising:
a. at least one user computer having at least one administrative software program;
b. a server unit in communication with the at least one user computer, comprising:
(i) a database for storing information concerning the at least one individual being monitored; and
(ii) a central processing unit having a plurality of application program modules for processing said information concerning the at least one individual being monitored;
at least one of said application program modules comprising a software integration function that receives and processes from said server unit information concerning the at least one individual being monitored, and formats said information for direct download into the at least one administrative software program in the at least one user computer; and
c. a means for relaying information concerning the at least one individual being monitored to said server unit.

2. The system of claim 1, wherein the information concerning the at least one individual being monitored comprises:
(a) identification information;
(b) task information; and,
(c) location information.

3. The system of claim 2, wherein said server unit communicates with said at least one user computer over a computer network; the server unit providing a navigable interface on the at least one user computer.

4. The system of claim 3, wherein said computer network comprises the Internet.

5. The system of claim 4, wherein said at least one user computer communicates with said server unit to enable said user to communicate with the at least one individual being monitored.

6. The system of claim 2, wherein the means for relaying to the server unit said information concerning the at least one individual being monitored comprises a telephone employing audio relay of such information to the user for manual entry into the server unit.

7. The system of claim 2, wherein the means for relaying to the server unit said information concerning the at least one individual being monitored comprises a wireless telecommunication device capable of automatic entry of such information concerning the at least one individual into the server unit.

8. The system of claim 2, wherein the means for relaying to the server unit said information concerning the at least one individual being monitored comprises a computer terminal capable of communication with said server unit for automatic entry of such information into the server unit.

9. The system of claim 2, further comprising a means for automatically determining a geographic position to identify location information.

10. The system of claim 9, wherein the means for automatically determining a geographic position comprises a space based GPS satellite system.

11. A method of monitoring the location and activity of at least one individual by a user with a communication system, comprising the steps of:
a. providing at least one user computer having at least one administrative software program;
b. providing a server unit in communication with the at least one user computer, comprising:
(i) a database for storing information concerning the at least one individual being monitored; and
(ii) a central processing unit having a plurality of application program modules for processing said information concerning the at least one individual being monitored;
at least one of said application program modules comprising a software, integration function that receives and processes from said server unit information concerning the at least one individual being monitored, and formats said information for direct download into the at least one administrative software program in the at least one user computer;
c. providing a means for relaying said information concerning the at least one individual being monitored to said server unit;
d. receiving at the server unit, transmission of information concerning the at least one individual being monitored from said means for relaying said information;
e. receiving at the server unit an authorization communicated by said at least one user computer to said server unit; and
f. in response to receipt of such authorization, processing and transferring at the server unit said formatted information concerning the at least one individual being monitored to the at least one administrative software program in the at least one user computer.

12. The method of claim 11, wherein the information concerning the at least one individual being monitored comprises:
(a) identification information;
(b) task information; and
(c) location information.

13. The method of claim 12, wherein said server unit communicates with said at least one user computer over a computer network; the server unit providing a navigable interface on the at least one user computer.

14. The method of claim 13, wherein said computer network comprises the Internet.

15. The method of claim 14, wherein said at least one user computer communicates with said server unit to further enable said user to communicate with the at least one individual being monitored.

16. The method of claim 12, wherein the means for relaying to the server unit said information concerning the at least one) individual being monitored comprises a telephone employing audio relay of said information concerning said at least one individual to the user for manual entry into the server unit.

17. The method of claim 12, wherein the means for relaying information concerning the at least one individual being monitored to said server unit is through a wireless telecommunication device.

18. The method of claim 12, wherein the means for relaying information concerning the at least one individual being monitored to said server unit comprises a computer terminal capable of communication with said server unit.

19. A method of monitoring the location and activity of at least one individual by a user with a communication system, comprising the steps of:
a. providing at least one user computer having at least one administrative software program;
b. providing a server unit in communication with the at least one user computer, comprising:
(i) a database for storing information concerning the at least one individual being monitored;
(ii) a central processing unit having a plurality of application program modules for processing said information concerning the at least one individual being monitored;
at least one of said application program modules comprising a software integration function that receives and processes from said server unit information concerning the at least one individual being monitored, and formats said information for direct download into the at least one administrative software program in the at least one user computer, and
c. providing a wireless telecommunication device for communicating information concerning the at least one individual being-monitored to said server unit including transmitting a position signal;
d. providing a means for automatically determining a geographic position to identify location information based upon such position signal transmission from said wireless telecommunication device;
e. receiving at the server unit, said position signal transmission from said wireless telecommunication device from which location information concerning the at least one individual being monitored may be determined;
f. receiving at the server unit, authorization information communicated by said at least one user computer to said server unit; and
g. in response to receipt of the authorization information, processing and transferring at the server unit said formatted information concerning the at least one individual being monitored to the at least one user computer.

20. The method of claim 19, wherein the information concerning the at least one individual being monitored comprises:
(a) identification information;
(b) task information; and
(c) location information.

21. The method of claim 20, wherein, the wireless telecommunication device comprises a cellular telephone.

22. The method of claim 20, wherein the means for determining geographic position comprises a space based GPS'satellite platform.
